(19) United States
(12) Patent Application Publication
(10) Pub. No.: US 2002/0147847 A1
(43) Pub. Date: Oct. 10, 2002

(54) System and method for remotely collecting and displaying data

(75) Inventors: Mark E. Brewster, Boulder, CO (US); Jason A. Heddings, Erie, CO (US)

Correspondence Address: LAHIVE & COCKFIELD, 28 STATE STREET, BOSTON, MA, 02109, US

(73) Assignee: Sun Microsystems, Inc.

(21) Appl. No.: 09/829,227

(22) Filed: Apr. 9, 2001

(51) Int. Cl. G06F 15/16

(52) U.S. Cl. 709/246

(57) ABSTRACT

A method for remotely compiling, converting, storing and displaying data is disclosed. The illustrated embodiment of the present invention converts data in documents submitted over a network into XML documents. The XML documents are stored in a central location where designated users may convert them into different viewable formats using a multitude of stylesheets, such as XSL stylesheets, thereby allowing display of the same data from a number of different viewpoints.

### FIELD OF THE INVENTION

The present invention relates generally to software and more particularly to remotely collecting and displaying data contained in documents submitted on a computer network.

### BACKGROUND OF THE INVENTION

Many business organizations require their employees to submit periodic reports. Traditionally, this sort of periodic reporting requirement was met by the mailing of paper reports to a designated collection point. With the development of computers, the reporting mechanism has evolved with employees in many cases now electronically submitting their reports to a designated repository. One manner in which this reporting is accomplished is through the employee completing a report and emailing the report to a specified destination. Alternatively, the reporting requirement may be met by the employee logging into the company network from a remote location and using software on the company network, such as StarOffice, from Sun Microsystems, Mountain View, Calif., to complete the report. The report is then saved on the company network. The employee may also submit the report by logging on to the company network and completing a template by answering questions. The template-based report is then saved on the company network. Once the report is saved on the company network or arrives at the company via email, a company administrator may review the employee report.

The company administrator reviewing the periodic reports submitted by the employee is constrained by the report format. The data in the report is encapsulated in a single format chosen by the employee in the case of an emailed report, or in a format chosen by the company in the case of a report that was completed using a company template or software on the company network. In either case, the data is displayed for the company administrator in a format not chosen by the administrator. Displaying the data contained in the report in an alternative format requires the administrator to reformat the data, a procedure which may be difficult. A method is needed whereby company administrators receive the data from periodic reports in a manner which lets the administrator easily view the data in multiple ways.

### SUMMARY OF THE INVENTION

The illustrative embodiment of the present invention provides a method for collecting data, such as periodic reports from members of a business organization, in a central location. The method provides for the automatic conversion of data into a specific format, such as the extensible markup language (XML), and the emailing of the data in the converted document to a designated recipient. The converted document is stored in a central location where it can be accessed by a designated user who is connected to the network. The method provides a mechanism for the designated user to manipulate the data in the converted document so that it may be displayed in a number of different ways.

In one embodiment of the present invention, a method for collecting reports over a computer network, such as periodic reports from members of a business organization, is disclosed. The method provides for the automatic extraction of data from a report and the creation of an extensible markup language (XML) document using the extracted data. The XML document may be emailed to a designated recipient. The reports are stored on a server interfaced with the network where the reports can be accessed by a designated user who is also connected to the network. The method provides a mechanism by which the XML document is translated using a stylesheet, such as an extensible stylesheet language (XSL) stylesheet, into a viewable format. This allows the data in the XML document to be displayed in a number of different ways to the designated user.

In another embodiment of the present invention, a method for collecting reports over a computer network, such as periodic reports from members of a business organization, is disclosed. The method provides for the automatic extraction of data from a report and the creation of an extensible markup language (XML) document using the extracted data. The XML document may be emailed to a designated recipient. The XML document is stored in a database connected to the network where it may be accessed by a designated user who is also connected to the network. The method provides a mechanism by which the XML document is translated using a stylesheet, such as an extensible stylesheet language (XSL) stylesheet, into a viewable format. This allows the data in the XML document to be displayed in a number of different ways to the designated user.

### BRIEF DESCRIPTION OF THE DRAWINGS

FIG. 1 depicts a block diagram of an environment suitable for practicing the illustrative embodiment of the present invention;

FIG. 2 is a flow chart of the overall sequence of steps performed by the method utilized by the illustrative embodiment of the present invention;

FIG. 3 is a flow chart of the sequence of steps performed by the illustrative embodiment of the present invention in converting a submitted report into an XML document.

### DETAILED DESCRIPTION OF THE INVENTION

The illustrative embodiment of the present invention provides a method for collecting and displaying data, such as periodic reports from members of a business organization, to designated users of a computer network. The method provides for the automatic conversion of data into a specific format, such as the extensible markup language (XML). The method also provides the capability of emailing the data contained in the XML document to a designated recipient. The XML document is stored in a specified location where it can be accessed by a designated user who is also connected to the network. The method provides a mechanism by which the XML document is translated using a stylesheet, such as an XSL stylesheet, into a viewable format. A designated viewer is therefore able to view a display of the data in the XML document in a number of different ways.

The majority of documents available on the internet today are stored in Hypertext Markup Language (HTML). HTML is a markup language that encodes a document via the use of tags and attributes. Tags appear between < > brackets, and attributes are specified in the form of “name=value”. HTML specifies the meaning of each tag and attribute and how text located between tags and/or attributes will appear. An example is a tag <p> which designates the beginning of a new paragraph. A corresponding tag </p> designates the end of the paragraph. HTML documents are typically interpreted by HTML interpreters found in web browsers.

The Extensible Markup Language (XML), was developed to provide greater flexibility than HTML for applications utilizing electronic documents. Similar to HTML, XML is a markup language that uses tags and attributes, but unlike HTML, XML uses tags only to delimit pieces of data. The interpretation given to the meaning of the data is left up to the application that reads the data. As noted above, the tag <p> in HTML specifies that a new paragraph is needed, whereas the tag <p> in XML has an application specific meaning. This flexibility allows applications making use of the data to interpret the data in different ways. The presentation of the data is separated from the content.

The ability to adjust the manner in which data is viewed by company administrators is greatly desired, as it allows administrators to more accurately interpret data. Once a document is in the XML format, it may be translated using a stylesheet into a viewable format. The stylesheet is a document that inserts data extracted from an XML document into a template for presentation to a user. Each stylesheet provides its own meaning to the tagged data in the XML document. The same data can be inserted into multiple stylesheets resulting in different presentations of the same data to a user.

In one embodiment of the present invention, periodic reports are submitted from company employees to a central location where the data in the reports is converted into an XML document. The data contained in the XML document may be emailed to a designated recipient and then stored. Company administrators who requested the periodic report may access the XML document and translate it into a viewable format using any of a number of XSL stylesheets. The use of any of a number of different XSL stylesheets to translate the data in the XML document allows the company administrator to view the data from a number of different viewpoints. The ability to view data from multiple viewpoints enhances the utility of the data received in the initial report. In an alternative embodiment, the stylesheet may be a Cascading Style Sheet (CSS).

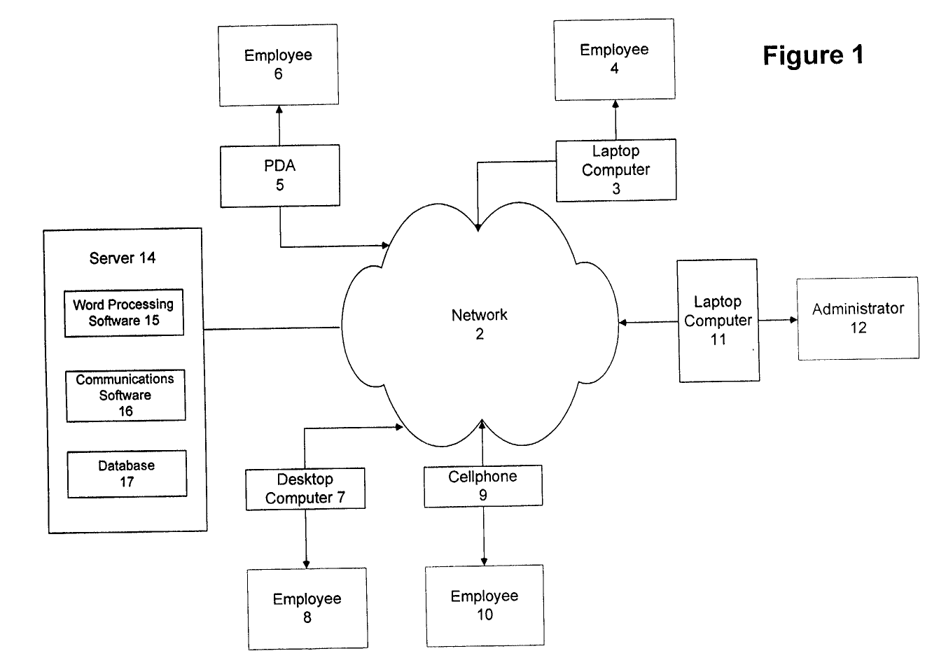

FIG. 1 depicts a block diagram of an environment suitable for practicing the illustrative embodiment of the present invention. Company employees 4, 6, 8, 10 submit reports over a network 2 to a server 14. The company employees 4, 6, 8, 10 may access network 2 though different client devices such as a laptop computer 3, a PDA 5, a desktop computer 7, or a cellular phone with wireless networking features 9. The network may be the Internet, an intranet or other type of network. A company administrator 12 may connect to the server 14 through the network 2 using his own laptop 11. Those skilled in the art will recognize that the company employees 4, 6, 8, 10 and administrator 12 may be interfaced with the network from different physical locations. The server 14 includes word processing software 15 that allows company employees 4, 6, 8, 10 to log on to the company server and create reports. The server 14 also has communications software 16 that includes an email program which allows company employees 4, 6, 8, 10 to email reports that are created off-site to the company server. Additionally, the server 14 includes a database 17 for storing reports on the server.

One embodiment of the present invention provides for company employees 4, 6, 8, 10 to submit periodic reports to a server 14. The data in the reports is extracted and converted into an XML document. An XML parser on the server is used to extract information from the report and place the extracted information and accompanying labels into an XML document. The data contained within the XML document is emailed to a designated recipient using the communication software 16 running on the server 14. In some embodiments, the designated recipient of the data contained within the emailed XML document may be a company administrator 12. In other embodiments, the designated recipient of the data contained within the emailed XML document may be someone other than the company administrator 12. The XML document may be stored on the server 14 in a database 17. In another embodiment, the XML documents are stored in a database located elsewhere on the network 2. Once stored, the XML documents may be retrieved by a company administrator 14 and translated using XSL stylesheet into different viewable formats. For example, the company administrator may wish to send the data contained in the reports to different recipients. In such a case, the administrator may decide that a viewable format resulting from the use of a stylesheet with one particular style would be very appealing to a first recipient, while a different viewable format resulting from the use of a stylesheet with a different style would be more appropriate for a second recipient.

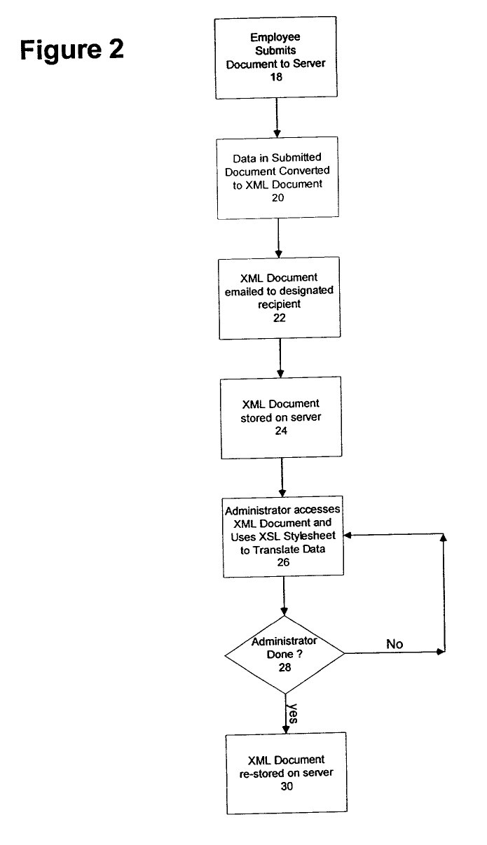

FIG. 2 depicts the sequence of steps followed by an illustrative embodiment of the present invention. The company employee 4 submits a document to the server 14 (step 18). The document may be a required periodic report, raw data, formatted data, or some other type of document. The document may be submitted as an attachment via email by the employee 4 or the employee may log on to the company network interfaced with the server 14, use company word processing software 15 to create the document, and send it to the server. The document created on the company network may be in a restricted format, such as a template, or the employee may design and create the document entirely. Those skilled in the art will realize that initial manner of creating the document is irrelevant to the present invention. Once on the server, the data in the submitted document is extracted and converted into an XML document (step 20). In some embodiments, the data contained in the XML document is emailed to a designated recipient (step 22) if an email recipient was identified at the time the original report was created. The designated recipient may be, but is not required to be, the company administrator 12 required to review the submitted documents. The XML document is then stored on the server after emailing (step 24). In other embodiments, the report creator may not designate an email recipient which causes the report to be stored immediately. The administrator 12 may access the stored XML document and use an XSL stylesheet to translate the XML document into a viewable format (step 26). After the administrator 12 has reviewed the displayed data (step 28), the administrator may use a different XSL stylesheet to display the data from the XML document in a different viewable format (step 26) or re-save the XML document on the server 12 (step 30). Those skilled in the art will recognize that the XML document could be stored on, and retrieved from, a database located remotely from the server without affecting the method disclosed by the present invention.

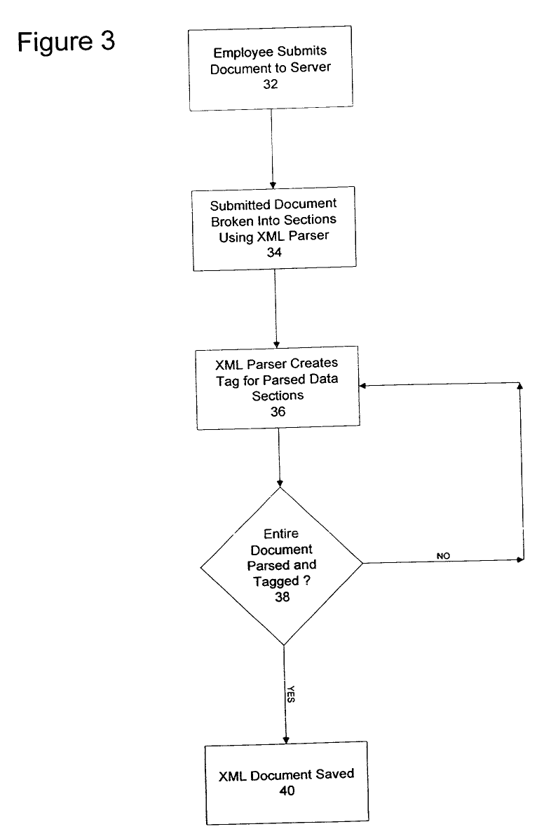

The sequence of events followed by an illustrative embodiment of the present invention in converting a submitted report into an XML document is depicted in FIG. 3. A company employee 4 submits a report over the network 2 to the server 14 (step 32). An XML document is generated from the submitted document by breaking up the submitted document into sections using a parser (step 34). The XML parser then creates an XML tag for the parsed data sections (step 36). This is done repeatedly until the entire submitted document has been parsed (step 38). The generated XML document may then be saved for later retrieval, by saving the document into a storage location such as a database (step 40).

If a recipient is designated at the time the original report was submitted, an email of the data contained within the XML document is generated. The format of the body of the email depends upon on the preference of the administrator 12. The email may contain the raw XML file or it may be displayed in any format by using a XSL translation to generate the email body. By doing this, the administrator may change the appearance of the generated email at any time if a different format is desired.

In one embodiment of the present invention the capability of programmatically sending an email of the data contained within the XML document is provided. A template used for the original document submission includes fields in which it is possible to designate an email recipient and field which allows a user to choose the format of the body of the email. Upon receipt of the template, computer-executable instructions on the server 14 check the email fields of the template. If an email recipient has been designated in the template field, the computer-executable instructions start the communications software 16 located on the server 14 and provide the name of the email recipient to the communications software. If an email body format is indicated in the template, the format is also provided to the communications software along with the data contained in the XML document. In other embodiments, a template is not used, but the computer-executable instructions stored on the server 14 analyze submitted documents for key words indicating an email recipient and/or email body format have been selected at the time the document was submitted.

The ability to present the same data via different stylesheets gives company administrators increased flexibility. Data viewed from different viewpoints enables administrators to arrive at a better understanding of the submitted data, thereby increasing its utility. The ability to format data using different stylesheets also enables a company administrator 12 to select a particular stylesheet for a particular audience if the administrator wishes to share the data with others.

It will thus be seen that the invention efficiently attains the objects made apparent from the preceding description. Since certain changes may be made without departing from the scope of the present invention, it is intended that all matter contained in the above description or shown in the accompanying drawings be interpreted as illustrative and not in a literal sense. Practitioners of the art will realize that the network configurations depicted and described herein are examples of multiple possible network configurations that fall within the scope of the current invention. The server 14 may be interfaced with a company network which is connected to the Internet. The company employees 4, 6, 8, 10 may be salesmen and submit their reports from the road. Alternatively, the company employees 4, 6, 8, 10 may be physically located locally to a company local area network while the server 14 may be located at a remote site. The network configurations are intended to be illustrative and not definitive.

We claim:

1. In a computer network, said network interfaced with a server, a method for collecting and presenting data, said method comprising the steps of:
receiving a first document, said first document submitted by a first user;
automatically converting data extracted from said first document into an extensible markup language (XML) document;
storing said XML document on said server; and
permitting access of said XML document from a remote location connected to said network by a second user.

2. The method of claim 1 comprising the additional step of:
automatically e-mailing the data contained within said XML document to a recipient, said recipient indicated by said first user when submitting said first document.

3. The method of claim 2 wherein said recipient is said second user.

4. The method of claim 2 wherein said recipient is different from said second user.

5. The method of claim 1 further comprising the steps of:
providing a stylesheet; and
applying said stylesheet to said XML document in response to commands from said second user.

6. The method of claim 1 comprising the further step of:
storing said XML document in a database connected to said network.

7. The method of claim 6 wherein said second user retrieves said XML document from said database.

8. The method of claim 7 further comprising the steps of:
providing an extensible stylesheet language (XSL) stylesheet; and
applying said XSL stylesheet to said XML document in response to commands from said second user.

9. In a computer network, said network interfaced with a database, a method for collecting and presenting data, said method comprising the steps of:
receiving a first document, said first document submitted by a first user;
automatically converting data extracted from said first document into an extensible markup language (XML) document;
storing said XML document in said database; and
permitting access of said XML document from a remote location connected to said network by a second user.

10. The method of claim 9 comprising the additional step of:
automatically e-mailing the data contained within said XML document to a recipient, said recipient indicated by said first user when submitting said first document.

11. The method of claim 10 wherein said recipient is said second user.

12. The method of claim 10 wherein said recipient is different from said second user.

13. The method of claim 9 further comprising the steps of:
providing a stylesheet; and
applying the stylesheet to said XML document in response to commands from said second user.

14. The method of claim 13 wherein said stylesheet is an XSL stylesheet.

15. In a computer network, said network including a server interfaced with a database, a medium holding computer-executable instructions for a method of collecting and displaying data, said method comprising the steps of:
receiving a first document, said first document submitted from a first user;
automatically converting data extracted from said first document into an XML document;
storing said XML document in said database; and
permitting access of said XML document from a remote location connected to said network by a second user.

16. The medium of claim 15 wherein said method comprises the additional step of:
automatically emailing said XML document to a recipient, said recipient indicated by said first user.

17. The medium of claim 16 wherein said recipient is different from said second user.

18. The medium of claim 15 wherein the method comprises the additional steps of:
providing a stylesheet; and
applying the stylesheet to said XML document in response to commands from said second user.

19. The medium of claim 18 wherein the stylesheet provided by said method is an XSL style sheet.

20. In a computer network, said network including a server, a medium holding computer-executable instructions for a method, said method comprising the steps of:
receiving a first document, said first document submitted from a first user;
automatically converting data extracted from said first document into an XML document;
storing said XML document on said server;
permitting access of said XML document from a remote location connected to said network, said access by a second user.

21. The medium of claim 20 wherein said method comprising the additional step of:
automatically emailing said XML document to a recipient, said recipient indicated by said first user.

22. The medium of claim 21 wherein said recipient is said second user.

23. The medium of claim 21 wherein said recipient is different from said second user.
